(19) United States
(12) Patent Application Publication
(10) Pub. No.: US 2018/0121962 A1
(43) Pub. Date: May 3, 2018

(54) ELECTRONIC APPARATUS AND CONTROLLING METHOD THEREOF

(71) Applicant: SAMSUNG ELECTRONICS CO., LTD., Suwon-si (KR)

(72) Inventors: Hee-ran LEE, Suwon-si (KR); Seung-min SHIN, Seoul (KR); Je-youn DONG, Suwon-si (KR); Mu-gong BAE, Suwon-si (KR); Hyun-don YOON, Pohang-si (KR)

(73) Assignee: SAMSUNG ELECTRONICS CO., LTD., Suwon-si (KR)

(21) Appl. No.: 15/802,885

(22) Filed: Nov. 3, 2017

(30) Foreign Application Priority Data
Nov. 3, 2016 (KR) 10-2016-0145816

(51) Int. Cl. G06Q 30/02; H04N 21/431; H04N 21/414; H04N 21/442

(52) U.S. Cl. CPC G06Q 30/0267; G06Q 30/0271; H04N 21/44222; H04N 21/431; H04N 21/41407; G06Q 30/0255

(57) ABSTRACT

An electronic apparatus and controlling method thereof are provided. The controlling method of an electronic apparatus includes generating a terminal-based content profile including content viewing history information and external apparatus usage information by time, transmitting the terminal-based content profile to an external server, in response to an event to play an advertisement content occurring, acquiring context information of the electronic apparatus and transmitting the acquired context information to the external server, receiving, from the external server, an advertisement content determined based on the terminal-based content profile and the context information of the electronic apparatus, and displaying the received advertisement content on a display.

### CROSS-REFERENCE TO RELATED APPLICATION(S)

This application claims priority from Korean Patent Application No. 10-2016-0145816, filed on Nov. 3, 2016 in the Korean Intellectual Property Office, the disclosure of which is incorporated herein by reference in its entirety.

### BACKGROUND

### 1. Field

Apparatuses and methods consistent with exemplary embodiments relate to an electronic apparatus and a controlling method thereof, and more particularly, to an electronic apparatus which provides a terminal-based advertisement content based on content viewing history information and external apparatus usage information through an external apparatus recognition, and a controlling method thereof.

### 2. Description of Related Art

Due to the development of a smart television (TV), users can be provided the advertisement related to a broadcast program while watching the broadcast program through the smart TV.

For example, an advertisement provider provides the advertisement appropriate for main viewers determined by analyzing the age group and the gender of the viewers who mainly watch a broadcast program.

In the related art, key words are acquired from a broadcast program and provided to an advertisement provider, and the advertisement provider provides the advertisement related to the key words to viewers. That is, in the related art, an advertisement is provided to the viewers based on the contents of a broadcast program.

In a related art advertisement providing method, the advertisement in which the current context information of the viewer watching a TV is not reflected can be provided to the viewer. For example, there is a problem in the conventional method that when the viewer is provided the contents such as a game etc. from the external apparatus connected to the TV and plays the contents on the screen of the TV, the advertisement which reflects the current context information such as characteristic information of the external apparatus and external apparatus usage history etc. is not provided to the viewer.

### SUMMARY

According to an aspect of an exemplary embodiment, there is provided a controlling method of an electronic apparatus, the method including: generating a terminal-based content profile including content viewing history information and external apparatus usage information by time; transmitting the terminal-based content profile to an external server; in response to an event to play an advertisement content occurring, acquiring context information of the electronic apparatus and transmitting the acquired context information to the external server; receiving, from the external server, an advertisement content determined based on the terminal-based content profile and the context information of the electronic apparatus; and displaying the received advertisement content on a display.

The content viewing history information may include information regarding a content that a user views for each time period obtained by using a content recognition technology and metadata received from an external server, wherein the external apparatus usage information may include characteristic information of the external apparatus, and wherein the context information of the electronic apparatus may include information regarding the external apparatus usage information currently recognized and information regarding a content currently being played.

The content recognition technology may include the electronic apparatus transmitting a characteristic of a content that is being watched to the external server, and receiving information regarding the content corresponding to the characteristic of the content from the external server.

The generating the terminal-based content profile may include generating the terminal-based content profile by mapping a viewing pattern of a user by time and by day.

The generating the terminal-based content profile may include accumulating a viewing time by content genre, and updating a name of a content most recently viewed on the terminal-based content profile.

The method may include determining, by the external server, a similarity between information included in a day and time of the terminal-based content profile and the context information corresponding thereto, wherein the received advertisement content corresponds to a content and an external apparatus of which the similarity is greater than a preset value.

The displaying may further include: displaying additional information related to a content currently being played and the context information of the electronic apparatus.

The content recognition technology may be at least one from among automatic content recognition (ACR) and optical content recognition (OCR).

According to an aspect of another exemplary embodiment, there is provided an electronic apparatus including: a display; a communicator configured to communicate with an external apparatus and an external server; a processor configured to: generate a terminal-based content profile including viewing history information and external apparatus usage information by time, transmit the terminal-based content profile to an external server through the communicator, in response to an event to play an advertisement content occurring, acquire context information of the electronic apparatus and transmit the acquired information to the external server through the communicator, receive an advertisement content determined based on the terminal-based content profile and the context information of the electronic apparatus from the external server through the communicator, and control the display to display the received advertisement content on the display.

The content viewing history information may include information regarding a content that a user watches for each time period obtained by using a content recognition technology and metadata received from an external server through the communicator, wherein the external apparatus usage information may include characteristic information of the external apparatus acquired from the external apparatus, and wherein the context information of the electronic apparatus may include the external apparatus usage information currently recognized and information regarding a content currently being played received from the external server through the communicator.

The processor may be further configured to transmit a characteristic of a content that is being viewed by the electronic apparatus to the external server though the communicator, and receive information regarding a content corresponding to the characteristic of the content from the external server through the communicator.

The processor may be further configured to map a viewing pattern of a user by time and by day, and generate the terminal-based content profile.

The processor may be further configured to accumulate a viewing time by content genre and update a name of a content most recently viewed to the terminal-based content profile.

The received advertisement content may correspond to a content and an external apparatus of which a similarity between information included in a day and time of the terminal-based content profile and the context information corresponding thereto, is greater than a preset value, the similarity being determined by the external server.

The processor may be further configured to control the display to display additional information related to a content currently being played and the context information of the electronic apparatus.

The content recognition technology may be at least one from among automatic content recognition (ACR) and optical content recognition (OCR)

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a view provided to illustrate an advertisement recommendation system environment, according to an exemplary embodiment;

FIG. 2 is a block diagram provided to illustrate a configuration of an electronic apparatus, according to an exemplary embodiment;

FIG. 3 is a block diagram provided to illustrate a configuration of an advertisement recommendation system environment, according to an exemplary embodiment;

FIG. 4 is a flowchart provided to illustrate a method for generating a terminal-based content profile in an electronic apparatus, according to an exemplary embodiment;

FIG. 5 is a view provided to illustrate characteristic information of an external apparatus, according to an exemplary embodiment;

FIG. 6 is a view provided to illustrate metadata of a content, according to an exemplary embodiment;

FIG. 7 is a view provided to illustrate a terminal-based content profile, according to an exemplary embodiment;

FIG. 8 is a view provided to illustrate a method for recommending an advertisement according to the context information of an electronic apparatus, according to an exemplary embodiment;

FIG. 9 is a sequence diagram provided to illustrate a method for providing an advertisement to an electronic apparatus in an advertisement recommendation system, according to an exemplary embodiment; and

FIG. 10 is a flowchart provided to illustrate a method for providing an advertisement to an electronic apparatus, according to an exemplary embodiment.

### DETAILED DESCRIPTION

Exemplary embodiments provide an electronic apparatus which provides a user terminal-based advertisement content based on the content viewing history information and external apparatus usage information, and a controlling method thereof.

According to one or more exemplary embodiments, the electronic apparatus and the controlling method thereof can provide more accurate terminal-based advertisement on the basis of the external apparatus information and the content viewing history information recognized by the electronic apparatus.

In addition, according to exemplary embodiments, an advertisement provider can provide more accurate customized advertisement to a viewer, and thus the effect of the advertisement can be improved.

In addition, according to exemplary embodiments, a broadcast content provider can provide a customized advertisement, and thus the broadcast content provider may charge more expensive advertisement fee to the advertisement provider.

The terms used in exemplary embodiments will be briefly explained, and exemplary embodiments will be described in greater detail with reference to the accompanying drawings.

A ‘module’ or a ‘unit’ performs at least one function or operation and may be implemented by hardware or software or a combination of the hardware and the software. In addition, a plurality of ‘modules’ or a plurality of ‘units’ may be integrated into at least one module and may be realized as at least one processor except for ‘modules’ or ‘units’ that should be realized in a specific hardware.

The expression, “at least one of A and B,” should be understood as including only “A,” or only “B,” or both “A and B.” Likewise, the expression “at least one of A, B, and C,” should be understood as including only A, only B, only C, both A and B, both A and C, both B and C, or all of A, B, and C.

A “content” may include various contents provided through the display of an electronic apparatus such as a video content which includes an audio, a video content which does not include the audio, a streaming content, an image content and the like.

In an exemplary embodiment, the “content being played” may include “the content being viewed”.

Exemplary embodiments will be described in greater detail below in a manner that will be understood by one of ordinary skill in the art. However, exemplary embodiments may be realized in a variety of different configurations, and are not limited to descriptions provided herein. Further, those that are irrelevant with the description are omitted so as to describe exemplary embodiments more clearly, and similar drawing reference numerals are used for the similar elements throughout the description.

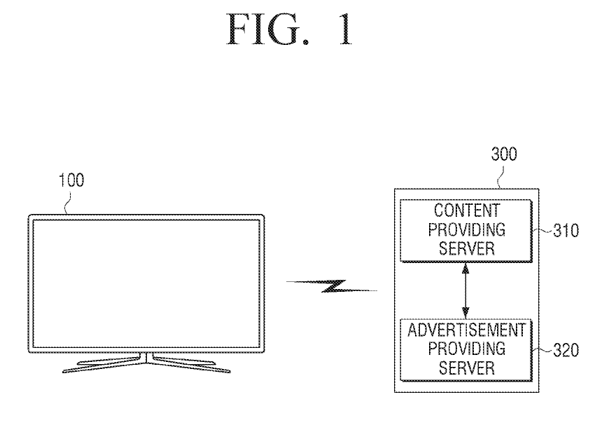

FIG. 1 is a view provided to illustrate an advertisement recommendation system environment according to an exemplary embodiment.

Referring to FIG. 1, an electronic apparatus 100 in an advertisement recommendation system may communicate with an external server 300 through a wired and/or wireless network. The external server 300 may include a content providing server 310 and an advertisement providing server 320, but not limited thereto. For example, the external server 300 may include an automatic content recognition (ACR) server and an optical content recognition (OCR) server, etc., and the ACR server and the OCR server may be included in the content providing server 310 and the advertisement providing server 320.

The electronic apparatus 100 may be a smart phone, a tablet Personal Computer (PC), a computer, a set top box, a personal digital assistant (PDA) etc., but not limited thereto.

The electronic apparatus 100 may play broadcast programs and various contents provided from the content providing server 310. The content providing server 310 may be a broadcaster which provides a TV program, but not limited thereto. For example, the content providing server 310 may be the server providing a streaming image online. In addition, the electronic apparatus 100 may play various contents provided from the recognized external apparatus.

An external apparatus 100 may be the external apparatuses input to an input terminal (e.g., a High-Definition Multimedia Interface (HDMI) etc.). In addition, the external apparatus may be other electronic apparatuses recognized wirelessly in the external apparatus 100 (e.g., a game console, a media play device etc.).

The electronic apparatus 100 may receive the information related to the content being played on the electronic apparatus 100 from the external server 300. For example, if the content being played in the electronic apparatus 100 is a broadcast program, the electronic apparatus 100 may receive various information related to the broadcast program being played from the external server 300. For example, the information related to the broadcast program may be various information such as program genre, a character and/or a location included in the content being played, and the like.

According to an exemplary embodiment, the electronic apparatus 100 may use the ACR technology and the OCR technology which receive the information related to the content provided to the electronic apparatus 100 through the external server 300. In addition, the electronic apparatus 100 may acquire the information related to the content by using a broadcast program application program interface (API) provided to the electronic apparatus 100. The above described exemplary embodiments are merely provided to describe an exemplary embodiment, and the electronic apparatus 100 may acquire the information related to the content by using various technologies.

According to an exemplary embodiment, the electronic apparatus 100 may generate a terminal-based content profile based on the information related to the content provided from the external server 300 and the characteristic information of an external apparatus recognized in the electronic apparatus 100. The characteristic information of the external apparatus may be a product identification, a sort, a name, usage history of the external apparatus, and the like.

The electronic apparatus 100 may receive the advertisement related to the content being played in the electronic apparatus 100 from the advertisement providing server 320. The advertisement providing server 320 may be an advertisement provider. The advertisement providing server 320 may receive the information related to the content provided to the electronic apparatus 100 from the content providing server 310. The advertisement providing server 320 may acquire the characteristic included in the content based on the content provided from the content providing server 310, and provide the advertisement that matches to each of the characteristic to the electronic apparatus 100. Here, according to an exemplary embodiment, the advertisement providing server 320 may provide the advertisement related to the content to the electronic apparatus 100 based on the terminal-based content profile generated in the electronic apparatus 100. In addition, the advertisement providing server 320 may provide the advertisement related to the content to the electronic apparatus 100 based on the context information of the electronic apparatus 100 received from the electronic apparatus 100.

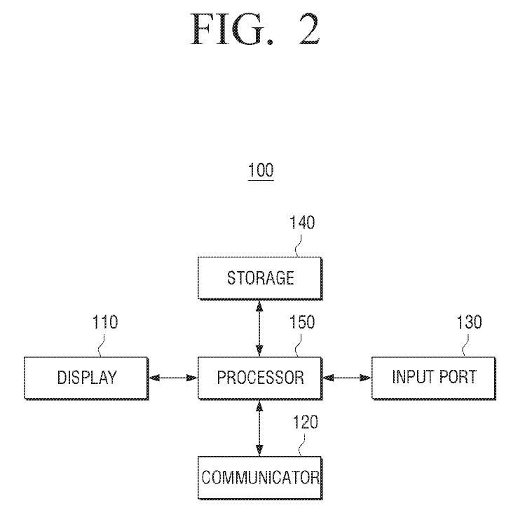

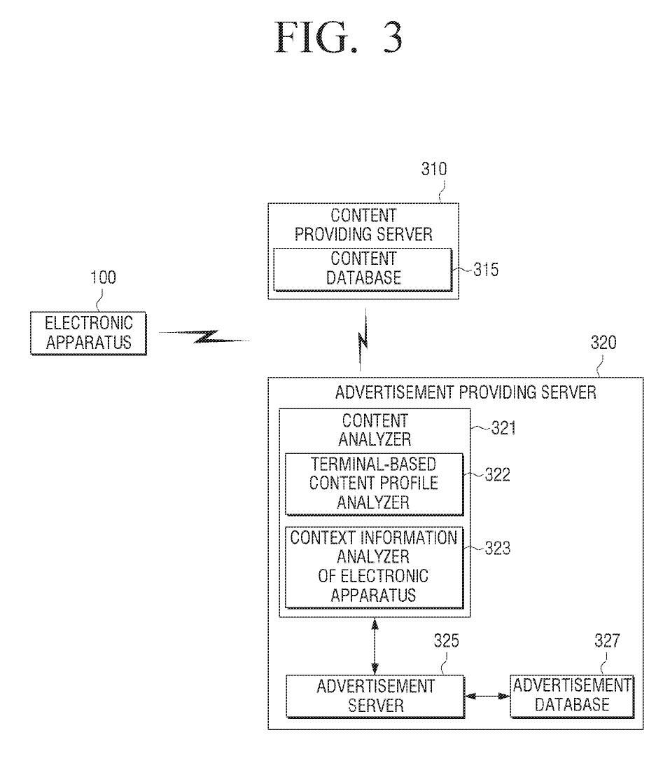

The configuration of the electronic apparatus 100 according to an exemplary embodiment will be illustrated in FIG. 2, and the configuration of the external server 300 will be illustrated in FIG. 3.

FIG. 2 is a block diagram provided to illustrate a configuration of an electronic apparatus according to an exemplary embodiment.

Referring to FIG. 2, the electronic apparatus 100 includes a display 110, a communicator 120, an input port 130, a storage 140 (e.g., memory), and a processor 150. Another element other than the elements illustrated in FIG. 2 may be added to the electronic apparatus 100, and some of the elements illustrated in FIG. 2 may be omitted from the electronic apparatus 100.

The display 110 may display various contents and various graphic user interfaces (GUIs). The display 110 may include a touch screen, and may be implemented in a flexible screen. The display 110 may be realized by using various technologies.

The communicator 120 may be communication interface, such as a transceiver (transmitter and receiver), configured to communicate with various types of external apparatuses and external servers according to various types of wired and/or wireless network communication methods.

The communicator 120 may include at least one from among a Wi-Fi chip, a Bluetooth chip, a wireless communication chip, a near field communication (NFC) chip, and a global positioning system (GPS) chip. The Wi-Fi chip and the Bluetooth chip may respectively perform communications according to a Wi-Fi method and a Bluetooth method. When the WI-FI chip or the Bluetooth chip is used, various connection information such as a service set identifier (SSID) and a session key may be first exchanged, and various information may be exchanged after a communication is connected by using the connection information. The wireless communication chip may mean a chip that performs communication according to various communication standards, such as the institute of electrical and electronics engineers (IEEE), ZigBee, third generation (3G), 3rd Generation Partnership Project (3GPP), Long Term Evolution (LTE), and the like. The NFC chip may mean a chip that operates by using a 13.56 MHz band from among various radio-frequency identification (RF-ID) frequency bands such as 135 kHz, 13.56 MHz, 433 MHz, 860 to 960 MHz, 2.45 GHz, and the like.

The communicator 120 may recognize the connection with an external apparatus. Various recognizing technologies may be used to recognize the external apparatus. The external apparatus may be various electronic apparatuses such as a USB, a game console, a smart phone etc. which are connected in wired or wireless network and which may provide a content to the electronic apparatus 100.

The communicator 120 may receive various contents in real time through a web site. The communicator 120 may receive the various contents through a wired or wireless network in various ways. According to an exemplary embodiment, the communicator 120 may include a communication module which may exchange the information related to ACR (Automatic Content Recognition) with an external server.

The input port 130 may be a configuration that an external apparatus may be input to the electronic apparatus 100. For example, if the electronic apparatus 100 is a TV, the input port 130 may be a HDMI terminal, a USB terminal, a set top box connection terminal and the like. The electronic apparatus 100 may recognize external apparatuses input to the input port 130, and acquire the information related to the recognized external apparatuses from the recognized external apparatus and an external server. The electronic apparatus 100 may recognize the external apparatus through a wireless network method, not through the input port 130.

The storage 140 may store various data information of the electronic apparatus 100 according to an exemplary embodiment. According to an exemplary embodiment, the storage 140 may store a terminal-based content profile. The storage 140 may acquire the information related to an external apparatus recognized through the communicator 120 from the external apparatus and/or an external server and store the acquired information. The storage 140 may store context information of the electronic apparatus 100.

The processor 150 may generate a terminal-based content profile including content viewing history information and external apparatus usage information by time, and transmit the generated profile to an external server through the communicator 110.

The processor 150 may generate the terminal-based content profile by mapping the viewing pattern of a user by day and by time.

The processor 150 may accumulate the viewing time for each content genre, and update the name of the content the most recently viewed to the profile.

The content viewing history information may include the information regarding the content being viewed by a user by time period by using the content recognition technology and metadata received from an external server through the communicator 120, but not limited thereto.

The content recognition technology may relate to that the electronic apparatus 100 transmits the characteristic of the content being viewed and receives the information regarding the content corresponding to the characteristic of the content from an external server, through the communicator 120.

Here, the characteristic of the content is the characteristic to divide the content currently being viewed from the other contents, for example, in case in which the content recognition using ACR, the characteristic of the content may be an audio/video fingerprint, and in the case in which the content recognition using OCR, the characteristic of the content may be text information such as a channel number, a channel name, a program name etc. and image information such as a broadcaster logo displayed on a screen. However, the above described examples of the content characteristic are merely provided to explain exemplary embodiments, and are not limited thereto. The content recognition technology is not limited to the ACR technology or OCR technology, and may be realized through various content recognition technologies.

The external apparatus usage information may include the characteristic information of the external apparatus acquired from the external apparatus, but not limited thereto.

If the event to play an advertisement content occurs, the processor 150 may acquire the context information of the electronic apparatus 100 and transmit the context information to an external server through the communicator 120.

The context information of the electronic apparatus 100 may include the recognized external apparatus usage information and the information regarding the content currently being played received from the external server through the communicator 120, but not limited thereto.

Here, the context information is the information regarding the content currently being played and the information regarding an external apparatus, and different from the terminal-based content profile corresponding to the history information which is accumulated data.

For example, if the processor 150 receives the event related to an advertisement content related to the content being played from an external server, the electronic apparatus 100 may acquire the current context information of the electronic apparatus 100.

For example, in the case in which a user watches a golf program through a TV 100, the user may receive an advertisement event related to the golf club of a golfer from a server when the golfer appears on the screen. Here, the processor 150 may acquire the information regarding the external apparatus recognized by the TV 100 and the information regarding the content in which the golfer appears, and transmit the acquired information to an external server.

The processor 150 may receive the advertisement content determined based on the terminal-based content profile and the context information of the electronic apparatus 100 from the external server through the communicator 120, and control the display 110 to display the advertisement content.

The advertisement content received from an external server corresponds to the content and the external apparatus of which the similarity between information included in a day and time of the terminal-based content profile and the context information of the electronic apparatus 100 corresponding thereto, is greater than a preset value, the similarity being determined by the external server.

For example, among the information stored in the terminal-based content profile, the proportion of the usage of game console 1 (an external apparatus) on Tuesday morning may be the highest. In addition, the information stored in the terminal-based content profile may include the record that advertisement 1, which relates to game content 1 played in game console 1 on Tuesday morning, was recommended.

While a user watches a golf program through the TV 100 on new Tuesday morning, if a golfer appears, the TV 100 may receive an advertisement event from an external server. Here, the processor 150 may acquire the external apparatus information recognized by the TV 100 and the information related to the content, and transmit the acquired information to the external server.

The external apparatus currently recognized by the TV 100 may be game console 1 and USB 1. The external server may compare advertisement 1 related to game console 1 which is the currently recognized external apparatus, advertisement 2 related to USB 1, and advertisement 3 related to the golf content currently being played with the terminal-based content profile (Tuesday morning, game console 1, and advertisement 1) information, and determine the similarity of the included information. If the determined similarity is greater than a preset value, the external server may transmit the corresponding advertisement to the electronic apparatus 100. The preset value may be set in the external server which is an advertisement provider. Alternatively, the external server may provide the advertisement of which a similarity is greater than a preset value with the advertisement related to the content currently being played, to the TV 100. The method for providing an advertisement from the external server to the electronic apparatus 100 may be implemented in a way that could maximize the profit of an advertisement provider.

For example, since the similarity of advertisement 1 related to game console 1 is the highest, the external server may provide advertisement 1 to the TV 100. Alternatively, the external server may provide advertisement 1, and advertisement 3 related to the content (e.g., a golf) currently being played to the TV 100.

The processor 150 may control the display 110 to display the additional information related to the content currently being played and the context information of the electronic apparatus 100.

For example, the processor 150 may control the display 110 to display the content currently played, the advertisement content received from an external server, the apparatus information regarding the external apparatus recognized in the electronic apparatus 100, the additional information related to the advertisement content, the additional information related to the content currently being played and the like. The user interface (UI) displayed on the display 110 may be transformed in various ways and implemented.

FIG. 3 is a block diagram provided to illustrate a configuration of an advertisement recommendation system environment according to an exemplary embodiment.

Referring to FIG. 3, the advertisement recommendation system may include the electronic apparatus 100, a content providing server 310 which is an external server, and an advertisement providing server 320.

The explanation of the electronic apparatus 100 was illustrated in FIG. 2.

The content providing server 310 may include a content database 315 which stores various contents and the information related thereto (e.g., metadata of the content etc.). The content database 315 may store the advertisement information related to the content provided from the advertisement providing server 320.

The content providing server 310 may further include the content recognition server which may use the ACR technology and/or the OCR technology which can determine which content the content is, by recognizing the content being played in the electronic apparatus 100. The content recognition server may be implemented as a content recognition module in a content analyzer 321 of the advertisement providing server 320.

The advertisement providing server 320 may include the content analyzer 321, an advertisement server 325, and an advertisement database 327.

The advertisement providing server 320 may analyze the terminal-based content profile generated in the electronic apparatus 100 and provide the advertisement optimized to the terminal to the electronic apparatus 100.

The content analyzer 321 may determine the advertisement to be recommended to the electronic apparatus 100 from the advertisements stored in the advertisement server 325 based on the information provided from the electronic apparatus 100. The content analyzer 321 may store the determined advertisement in the advertisement database 327.

A terminal-based content profile analyzer 322 of the content analyzer 321 and a context information analyzer 323 of the electronic apparatus may determine the advertisement to be recommended that corresponds to the content, by using a content recognition technology.

The terminal-based content profile analyzer 322 may analyze the content viewing history information and the external apparatus usage information included in the terminal-based content profile received from the electronic apparatus 100. The terminal-based content profile analyzer 322 may determine the advertisement which may be recommended to the characteristic information of the external apparatus based on the external apparatus usage information. In addition, the terminal-based content profile analyzer 322 may determine the advertisement which may be recommended to the content based on the content viewing history information.

The context information analyzer 323 of the electronic apparatus may determine the advertisement which may be recommended to the external apparatus currently recognized, based on the characteristic information of the recognized external apparatus and the external apparatus usage information received from the electronic apparatus 100. The context information analyzer 323 of the electronic apparatus may determine the advertisement related to the content currently being played received from the electronic apparatus 100.

The content analyzer 321 compares the result determined in the terminal-based content profile analyzer 322 and the result determined in the context information analyzer 323 of the electronic apparatus, and determines the similarity of the determined advertisements.

The content analyzer 321 may determine the advertisement, which is the most similar to the advertisement to be recommended to the electronic apparatus 100 determined in the context information analyzer 323 of the electronic apparatus among the advertisements to be recommended to the electronic apparatus 100 determined in the terminal-based content profile analyzer 322, as the advertisement to be provided to the electronic apparatus 100. In addition, the content analyzer 321 may determine the advertisements of which the similarity is greater than a preset value as the advertisement to be provided to the electronic apparatus 100. An advertiser may transform and realize the advertisement providing algorithm according to the similarity result of the content analyzer 321 so as to recommend the optimum advertisement to the electronic apparatus 100 which is a user-based terminal.

The advertisement server 325 may provide an advertisement to the electronic apparatus 100 through a wireless network communication method. The advertisement server 325 may provide the advertisement optimized to the content provided from the content providing server 310 to the electronic apparatus 100. The advertisement database 327 may store the information (e.g., metadata etc.) related to the advertisement which may be recommended to the content provided from the content providing server 310. The advertisement database 327 may store the data analyzed in the content analyzer 321.

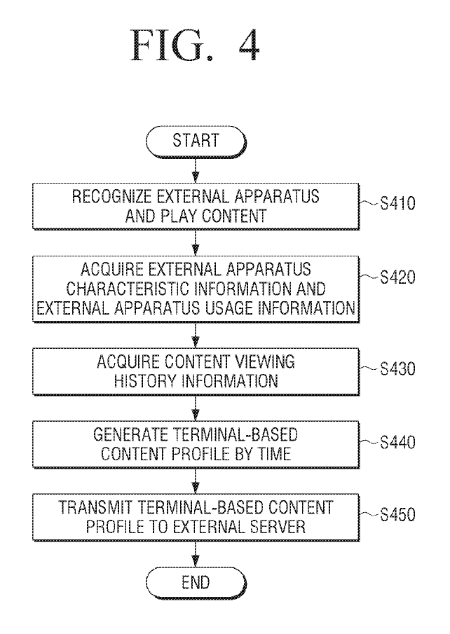

FIG. 4 is a flowchart provided to illustrate a method for generating a terminal-based content profile in an electronic apparatus according to an exemplary embodiment.

Referring to FIG. 4, in the stage of S410, the electronic apparatus 100 may recognize the external apparatus connected to the electronic apparatus 100 in a wired and/or wireless communication method. In addition, the electronic apparatus 100 may play the content received from the content providing server or from the recognized external apparatus.

For example, the electronic apparatus 100 may play the broadcast program content by receiving a TV program from a broadcaster. In addition, the electronic apparatus 100 may receive a game content from an external apparatus such as a game console and play the game content.

In another example, the electronic apparatus 100 may play the content provided from the other electronic apparatus connected in a wireless communication method. The electronic apparatus 100 may play the streaming content in real time through a web site in a wireless communication method. The above described examples are merely provided to describe exemplary embodiments, and are not limited thereto. The electronic apparatus 100 may play the content provided in various ways.

In the stage of S420, the electronic apparatus 100 may acquire the characteristic information of the recognized external apparatus and the external apparatus usage information.

The characteristic information of the electronic apparatus may be various information such as the name of the external apparatus, the apparatus identification, the sort of the apparatus, the sort of the content provided from the apparatus, the user identification set in the apparatus etc. The external apparatus usage information may be the information such as the usage time that the content provided from the external apparatus is played in the electronic apparatus 100.

The electronic apparatus 100 may acquire the characteristic information of the external apparatus from the ‘device knowledge database’ stored in the external apparatus. In addition, the electronic apparatus 100 may transmit the characteristic information of the external apparatus to the external server, and acquire the characteristic information in real time through the external server.

The electronic apparatus 100 may store the information related to the acquired external apparatus in the storage of the electronic apparatus 100.

In the stage of S430, the electronic apparatus 100 may acquire the content viewing history information. The content viewing history information may include various information related to the playback of the content such as the channel information provided through the electronic apparatus 100, and the viewing time.

For example, if the electronic apparatus 100 is a TV, the TV may acquire the content viewing history information through the tuner information in the TV. In addition, the TV may acquire the content viewing history information by using the ACR technology which uses the Internet or audio/video finger print information and by using the OCR technology which uses image information.

In addition, the electronic apparatus 100 may acquire the metadata related to the content from the external server which includes the content database. For example, if the content is a broadcast program, the content metadata may include various information of the content (channel name, type of a channel, start time, finish time etc.) according to the region information, the channel name, and the apparatus information.

The stages from S410 to S430 may be implemented by changing the order thereof.

In the stage of S440, the electronic apparatus 100 may generate the terminal-based content profile by time based on the information related to the acquired external apparatus and the information related to the content.

The electronic apparatus 100 may generate the terminal-based content profile by using the characteristic information of the acquired external apparatus, the external apparatus usage history information, the content viewing history information, the metadata of the content.

For example, the electronic apparatus 100 may generate a matching table based on the viewing history information and the external apparatus usage information by dividing the content being played (viewed) by time/day unit. For example, if the electronic apparatus 100 is a TV, the electronic apparatus 100 may generate the matching table by using the channel name which provides the content, the channel genre, the content genre, the content name etc. In addition, the electronic apparatus 100 may add the external apparatus usage information to the matching table by day and time units by using ‘knowledge database’ which is the characteristic information of the external apparatus itself.

In another example, the electronic apparatus 100 may generate the matching table by accumulating the genre of the channel which provides the content and the viewing time of the content genre and by storing the content name the most recently being viewed. In addition, the electronic apparatus 100 may generate the matching table according to the usage class or the viewing class of the content.

However, the above described examples are merely provided to describe exemplary embodiments and are not limited thereto, and the terminal-based content profile may be generated with various categories.

In the stage of S450, the electronic apparatus 100 may transmit the generated terminal-based content profile to an external server. The external server may be the advertisement providing server to which the advertiser may approach.

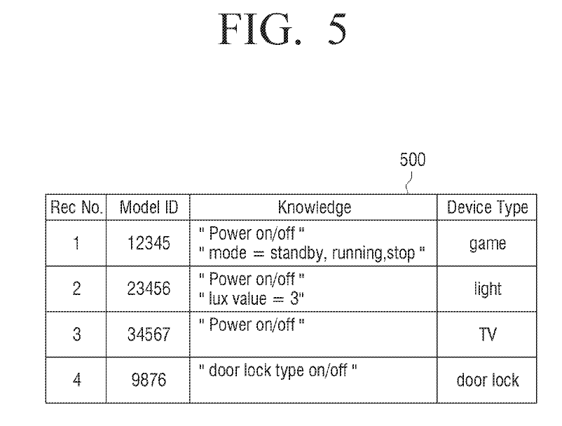

FIG. 5 is a view provided to illustrate the characteristic information of an external apparatus according to an exemplary embodiment.

Referring to FIG. 5, the characteristic information 500 of the external apparatuses recognized in the electronic apparatus 100 may include the number recognized in the electronic apparatus 100 (Rec. No.), the model identifier of the external apparatus (Model ID), an operation algorithm of the external apparatus (Knowledge), and the device type of the external apparatus.

For example, the electronic apparatus 100 may recognize the external apparatus by using various external apparatus recognition technologies. The electronic apparatus 100 may acquire the characteristic information regarding the external apparatus based on the information such as the model identifier, the operation algorithm, the type of the recognized external apparatus. In addition, if a content is provided to the electronic apparatus 100 through the external apparatus, the electronic apparatus 100 may acquire the usage information that the content provided from the external apparatus is played (viewed) in the electronic apparatus 100 and store the usage information in the storage of the electronic apparatus 100.

For example, if the external apparatus recognized by the electronic apparatus 100 is a game apparatus and a game content is provided from the game apparatus, the electronic apparatus 100 may add the information related to the game apparatus usage information and the game content to the terminal-based content profile illustrated in FIG. 4 based on the characteristic information regarding the game apparatus.

For another example, if the external apparatus recognized by the electronic apparatus 100 is a locking device (e.g., door lock), the electronic apparatus 100 may add the characteristic information regarding the locking device, the maintenance time that the locking device is recognized in the electronic apparatus 100, and the usage information that the locking device is controlled by the electronic apparatus 100 etc., while the content is being played in the electronic apparatus 100, to the terminal-based content profile illustrated in FIG. 4.

In addition, if an advertisement event occurs, the electronic apparatus 100 may acquire the characteristic information regarding the external apparatus recognized at the moment that the advertisement event occurs and the usage information of the external apparatus, and provide the acquired information to the external server.

The characteristic information 500 of the external apparatus illustrated in FIG. 5 is provided to explain an exemplary embodiment, which illustrates the information of the external apparatus. Accordingly, the characteristic information and the usage information of the external apparatus may include various additional information.

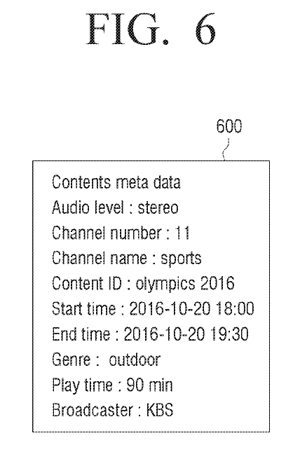

FIG. 6 is a view provided to illustrate metadata of a content according to an exemplary embodiment.

Referring to FIG. 6, the metadata 600 of the content played (viewed) in the electronic apparatus 100 may include an audio level, a channel number, a channel name, a content identification, start time, closing time, genre, play time, information of the broadcaster which is a content provider. However, the metadata information illustrated in FIG. 6 is merely provided to illustrate an exemplary embodiment, and is not limited thereto. The metadata information illustrated in FIG. 6 may include various information.

The external server which provides an advertisement to the electronic apparatus 100 may tag the advertisement corresponding to the information to be targeted based on the information included in the content metadata and the content viewing history information, and store the tagged advertisement.

For example, the information included in the metadata 600, “Olympic 2016” and “outdoor”, may be the targeting information to provide an advertisement. The external server may tag the advertisement item corresponding to the “Olympics 2016” and “outdoor” and store the item in the advertisement database of an external server. If the external server received the “Olympics 2016” and “outdoor” from the content viewing history information of the electronic apparatus 100, the electronic apparatus 100 may receive the advertisement respectively corresponding to the “Olympic 2016” and “outdoor” from an advertiser at the time set by the advertiser.

According to an exemplary embodiment, if an advertisement event occurs in the electronic apparatus 100, the electronic apparatus 100 may receive the context information of the electronic apparatus 100 in the external server. Here, the information related to the content currently being played and the information related to the recognized external apparatus which are included in the context information acquired in the electronic apparatus 100 may be included in the metadata 600 and provided to the external server. The external server may determine the targeted information based on the information included in the metadata 600, tag the advertisement corresponding to the targeting information and store the tagged advertisement in the advertisement database.

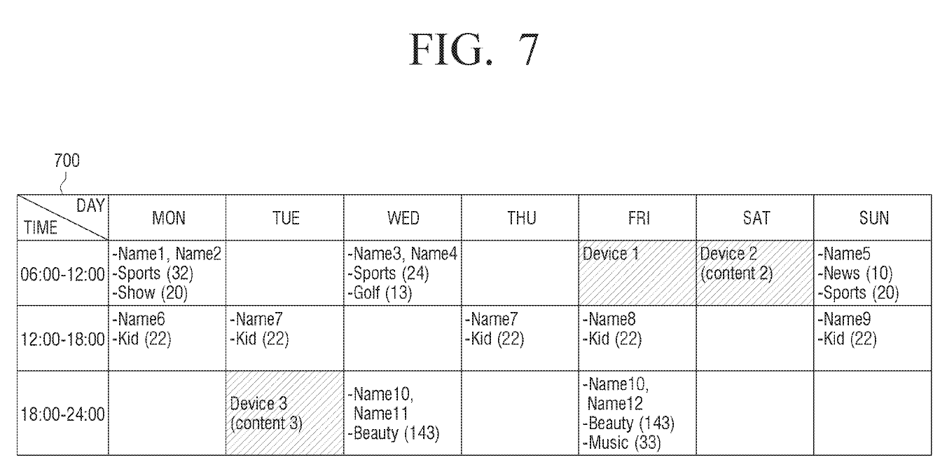

FIG. 7 is a view provided to illustrate a terminal-based content profile according to an exemplary embodiment.

Referring to FIG. 7, the terminal-based content profile 700 may be a matching table form in which the content viewing history information and the external apparatus usage information are divided by day and by time. However, the matching table illustrated in FIG. 7 is merely provided to explain an exemplary embodiment, and is not limited thereto. The matching table illustrated in FIG. 7 may transform the terminal-based content profile 700 with various information.

For example, the terminal-based content profile 700 may be generated by being divided by day unit according to morning time (06:00˜12:00), afternoon time (12:00-18:00), and night time (18:00-24:00).

The terminal-based content profile 700 may include the information such as content names (e.g., Name 1˜Name 10), content genres (e.g., sports, show, kid, golf, news, beauty, and music), channel numbers (e.g., 32, 20, 24, 13, 10, 20, 22, 143, and 33), external apparatus names (e.g., Device 1, Device 2, and Device 3), contents provided from an external apparatus (e.g., content 2, content 3) and the like.

For example, the electronic apparatus 100 may acquire the pattern information that the electronic apparatus 100 is used by connecting the external apparatus (e.g., Device 1, Device 2) on the morning time, and on Friday and Saturday. In addition, the electronic apparatus 100 may acquire the pattern information that the content of Name 10 is viewed on a beauty channel 143 at Wednesday and Thursday night.

Accordingly, the external server may provide the advertisement content optimized to the electronic apparatus 100 based on the terminal-based content profile 700. In addition, the external server may provide the advertisement content optimized to the context of the electronic apparatus 100 by comparing the context information received from the electronic apparatus 100 and the terminal-based content profile 700 information.

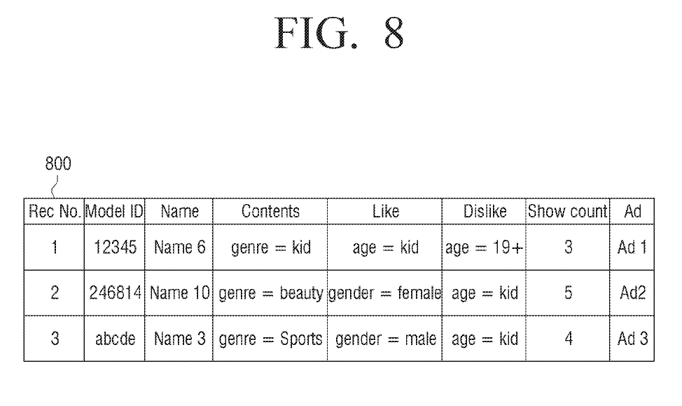

FIG. 8 is a view provided to illustrate a method for recommending an advertisement according to the context information of an electronic apparatus according to an exemplary embodiment.

If an advertisement content event occurs while a content is played, the electronic apparatus 100 may acquire the context information of the electronic apparatus 100 and provide the acquired information to an external server.

The context information of the electronic apparatus 100 may be the information related to the external apparatus currently recognized by the electronic apparatus 100 and the information related to the content currently being played.

Referring to FIG. 8, the electronic apparatus 100 recognizes three external apparatuses and generates the advertisement corresponding to the external apparatuses and the content based on the model identifier, content names (e.g., Name 6, Name 10, and Name 3), content genre, content preferred object, content nonpreferred object, and a show count of each of the external apparatuses as a matching table 800. The matching table 800 is merely provided to explain an exemplary embodiment, and the algorithm of an exemplary embodiment may be realized in various ways.

For example, a user may view the content of which the broadcast program name is Name 6 through the electronic apparatus 100 on Monday afternoon (15:00-16:00) and there may be no recognized external apparatus. The electronic apparatus 100 may acquire the content viewing history information regarding Name 6 through an external server. The electronic apparatus 100 may generate the terminal-based content profile including the content viewing history information and the external apparatus usage information.

If the electronic apparatus 100 receives an advertisement content event from an external server, the electronic apparatus 100 may acquire the context information of the electronic apparatus 100 and transmit the context information to the external server.

For example, the electronic apparatus 100 may receive the advertisement content playback event corresponding to Name 6 on afternoon 15:30 from an advertisement providing server. The electronic apparatus 100 may acquire the context information of the electronic apparatus 100 and transmit the context information to an external server. In addition, the electronic apparatus 100 may transmit the information related to the external apparatus recognized at afternoon 15:30 and the information related to the content currently being played to the external server. For example, the external apparatus recognized in the electronic apparatus 100 at afternoon 15:30 may be “Device 1” of which “model ID” is “12345”. In addition, the program name and the content genre of the information of the content being viewed by a user at afternoon 15:30 may be Name 6 and “kid”, respectively.

The external server may provide the advertisement corresponding to the context information to the electronic apparatus 100 by using the context information of the electronic apparatus 100 and terminal-based content profile generated in the electronic apparatus 100. The external server may determine the similarity of the context information of the electronic apparatus 100 among the information included in the day and time of the terminal-based content profile illustrated in FIG. 7, and provide the advertisement content corresponding to the content and the external apparatus of which the determined similarity is greater than a preset value, to the electronic apparatus 100.

For example, in the electronic apparatus 100, since the day when Name 6 is played is Monday and the time when Name 6 is played is included in the afternoon time period (12:00-18:00) of the terminal-based content profile illustrated in FIG. 7, the external server may analyze the information such as the content information which is targeted on Monday afternoon in the terminal-based content profile, the external apparatus information, and the advertisement tagging corresponding to the above information, and the like. The external server may determine the advertisement corresponding to the context information (Device 1, Name 6) of the electronic apparatus 100 received from the electronic apparatus 100 at the present time (Monday, afternoon 15:30). The external server may provide the advertisement “Ad 1” corresponding to Name 6 to the electronic apparatus 100, since the usage history regarding Device 1 is not included in the Monday afternoon usage history of the terminal-based content profile illustrated in FIG. 7, and there are three times of usage histories of the show time of the content regarding Name 6 as illustrated in FIG. 8. The electronic apparatus 100 may display “Ad 1”.

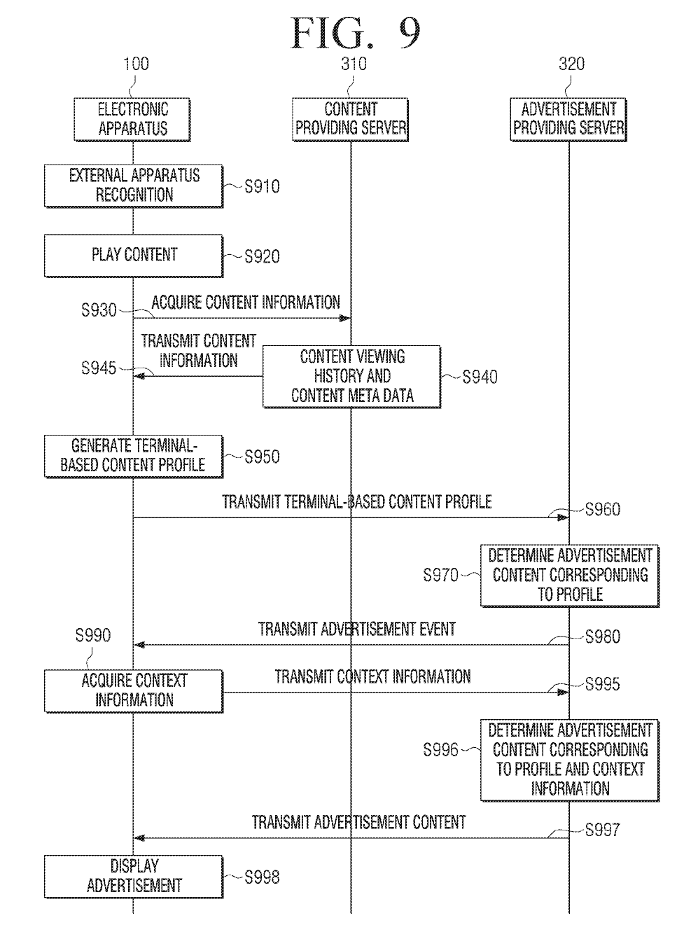

FIG. 9 is a sequence diagram provided to illustrate a method for providing an advertisement to an electronic apparatus in an advertisement recommendation system according to an exemplary embodiment.

Referring to FIG. 9, in the stage of S910, the electronic apparatus 100 may recognize the external apparatus connected to the electronic apparatus 100 in a wired and/or wireless communication method by using various external apparatus recognition technologies.

In the stage of S920, the electronic apparatus 100 may play the content provided in various methods such as the content provided from the content providing server 310, the content stored in the electronic apparatus 100, or the content provided from an external apparatus. The order of stage S910 and S920 may be changed.

In the stage of S930, the electronic apparatus 100 may ask the content providing server 310 for the content information.

In the stage of S940, the content providing server 310 may analyze the information related to the content by using the content recognition technology and generate the information related to the content such as content viewing history. In addition, the content providing server 310 may store the metadata regarding the content.

In the stage of S945, the content providing server 310 may transmit content information such as content viewing history information and content metadata.

In the stage of S950, the electronic apparatus 100 may generate the terminal-based content profile based on the content viewing history information, the content metadata, the characteristic information of an external apparatus and the external apparatus usage information which are related to the external apparatus, and the like. The terminal-based content profile may be divided by content viewing time and by day unit and generated as a matching table. Accordingly, the terminal-based content profile may include the information related to the content viewing pattern of the user who uses the electronic apparatus 100.

In the stage of S960, the electronic apparatus 100 may transmit the terminal-based content profile to the advertisement providing server 320.

In the stage of S970, the advertisement providing server 320 may determine the advertisement content corresponding to the terminal-based content profile. The advertisement providing server 320 may determine the information to be targeted among the information related to the content included in the content profile and the information related to an external apparatus, tag the advertisement corresponding to the information to be targeted, and store the tagged advertisement in the advertisement database.

In the stage of S980, if the information to be targeted on the content being played in the electronic apparatus 100 is included, the advertisement providing server 320 may transmit the advertisement event to the electronic apparatus 100.

In the stage of S990, if the advertisement content event is received from the advertisement providing server 320, the electronic apparatus 100 may acquire the context information of the electronic apparatus 100.

The context information of the electronic apparatus 100 may include the characteristic information regarding the external apparatus currently recognized by the electronic apparatus 100 and the usage information of the external apparatus. In addition, the context information of the electronic apparatus 100 may be the information related to the content currently being played on the electronic apparatus 100.

In the stage of S995, the electronic apparatus 100 may transmit the acquired context information of the electronic apparatus 100 to the advertisement providing server 320.

In the stage of S996, the advertisement providing server 320 may determine the advertisement content corresponding to the context information of the electronic apparatus 100 and the terminal-based content profile.

For example, the advertisement providing server 320 may determine the similarity between the information included in a day and time of the terminal-based content profile and the context information of the electronic apparatus 100 corresponding thereto, and provide the advertisement content corresponding to the content and the external apparatus of which the determined similarity is greater than a preset value to the electronic apparatus 100 (S997).

In the stage of S998, the electronic apparatus 100 may display the advertisement received from the advertisement providing server 320. The electronic apparatus 100 may display the received advertisement together with the content being played. In addition, the electronic apparatus 100 may display the additional information related to the content currently being played and the additional information related to the external apparatus currently recognized together with the received advertisement.

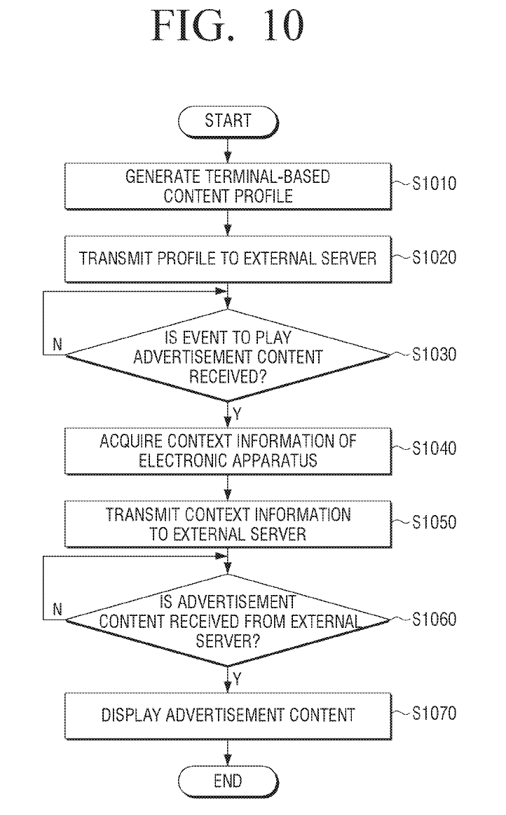

FIG. 10 is a flowchart provided to illustrate a method for providing an advertisement to an electronic apparatus according to an exemplary embodiment.

Referring to FIG. 10, in the stage of S1010, the electronic apparatus 100 may generate the terminal-based content profile including the content viewing history information and the external apparatus usage information.

For example, if a content is played in the electronic apparatus 100, the electronic apparatus 100 may acquire the information related to the content from an external server by using the ACR technology, the OCR technology, the API displayed on the electronic apparatus 100, and store the acquired information in a storage. The information related to the content may include various information such as content channel information, content genre and the like, and content metadata.

The electronic apparatus 100 may recognize the external apparatuses connected to the electronic apparatus 100 in a wired and/or wireless communication method by using an external apparatus recognition technology. The electronic apparatus 100 may acquire the characteristic information and the usage information of the recognized external apparatus and store the acquired information in the storage.

The electronic apparatus 100 may divide the terminal-based content profile including the acquired content viewing history information and external apparatus usage information by day and by time, and generate a matching table. The above described examples are provided to explain an exemplary embodiment, and the profile may be generated by time and by day units and may be transformed in various ways.

In the stage of S1020, the electronic apparatus 100 may transmit the generated profile to an external server.

In the stage of S1030, if the electronic apparatus 100 receives the event to play an advertisement content from an external server (Y), the electronic apparatus 100 may acquire the context information of the electronic apparatus 100 in the stage of S1040.

The context information of the electronic apparatus 100 may include the characteristic information of the currently recognized external apparatus, and the external apparatus usage information. The context information may include the information related to the content currently being played in the electronic apparatus 100.

In the stage of S1050, the electronic apparatus 100 may transmit the acquired context information to an external server.

If an advertisement content is received form the external server in S1060, the electronic apparatus 100 may display the received advertisement content in S1070. The electronic apparatus 100 may display the advertisement content received together with the currently played content. The electronic apparatus 100 may display the additional information related to the content currently being played and the additional information related to the currently recognized external apparatus.

According to an above described exemplary embodiment, the electronic apparatus 100 may determine the current context of a user who views the content and provide the optimum advertisement to the user.

For example, if Device 1 which is a game apparatus is connected to the HDMI, an input port of the electronic apparatus 100, the electronic apparatus 100 may provide Content 1 which is the game content corresponding to Device 1, as an advertisement.

For another example, the information that the game of which title is Content 1 is played on the electronic apparatus 100 may be stored in the terminal-based content profile through Device 1. Here, the electronic apparatus 100 may receive an advertisement event from the external server, and the currently recognized external apparatus among the context information of the electronic apparatus 100 may be Device 1. The electronic apparatus 100 may acquire the characteristic information and usage information of Device 1 from ‘Knowledge database’ of Device 1. The electronic apparatus 100 may receive the advertisement of which a game title is Content 2 and which is a target advertisement related to Content 1 of Device 1 from an external server.

For another example, the electronic apparatus 100 may store the terminal-based content profile that the children's program is played in the morning and a game is played with a game console in the afternoon. Here, the electronic apparatus 100 may receive the advertisement for targeting the children related to the children's program in the morning. The electronic apparatus 100 may receive the advertisement corresponding to the type of the game console and the game contents which is frequently used in the afternoon even if the other content is played in the afternoon.

For another example, the electronic apparatus 100 may provide different advertisements according to the characteristic of the external apparatus recognized by the electronic apparatus 100. For example, the history that Device 1 which is a game console and Device 2 which is a media player are connected to the electronic apparatus 100 and different contents are played in each of the external apparatuses, may be stored in the terminal-based content profile. The external server may determine the priority of the advertisements to determine which advertisement is to be provided first among the advertisements corresponding to each of the devices based on the usage history that Device 1 and Device 2 are used in the electronic apparatus 100 and based on the content information provided from each of the devices. For example, if Device 1 and Device 2 are connected to the electronic apparatus 100 concurrently, the external server may provide the advertisement corresponding to the external apparatus which has been more used between Device 1 and Device 2 to the electronic apparatus 100.

The above described scenarios are provided to explain an exemplary embodiment, and is not limited thereto.

One or more exemplary embodiments may be implemented as a code which is readable by a computer in the recording medium readable by a computer, although not limited thereto. The recording medium readable by a computer includes all sorts of recording mediums in which the data readable by a computer system is stored. The example of the computer readable recording medium includes read only memory (ROM), random access memory (RAM), compact disc read only memory (CD-ROM), a magnetic tape, a floppy disk, and an optical data storage device. The computer readable recording medium may disperse in computer systems that are connected over a network so that a code readable by a computer may be stored and executed in a dispersion method. In addition, an exemplary embodiment may be recorded as a computer program transmitted through the computer readable transmitting medium such as a carrier wave, and may be received in the general purpose or special purpose digital computer and implemented. Also, in the exemplary embodiments, more than one units of the above described apparatuses may include a circuit, a processor, a microprocessor, and may execute the computer program stored in the computer readable medium.

Also, the description of exemplary embodiments is intended to be illustrative, and not to limit the scope of the claims, and it would be appreciated by those skilled in the art that changes may be made to exemplary embodiments without departing from the principles and spirit of the disclosure, the scope of which is defined in the appended claims.

What is claimed is:

1. A controlling method of an electronic apparatus, the controlling method comprising:
generating a terminal-based content profile comprising content viewing history information and external apparatus usage information by time;
transmitting the terminal-based content profile to an external server;
in response to an event to play an advertisement content occurring, acquiring context information of the electronic apparatus and transmitting the acquired context information to the external server;
receiving, from the external server, an advertisement content determined based on the terminal-based content profile and the context information of the electronic apparatus; and
displaying the received advertisement content on a display.

2. The controlling method as claimed in claim 1, wherein the content viewing history information comprises information regarding a content that a user views for each time period obtained by using a content recognition technology and metadata received from an external server,
wherein the external apparatus usage information comprises characteristic information of the external apparatus, and
wherein the context information of the electronic apparatus comprises information regarding the external apparatus usage information currently recognized and information regarding a content currently being played.

3. The controlling method as claimed in claim 2, wherein the content recognition technology comprises the electronic apparatus transmitting a characteristic of a content that is being watched to the external server, and receiving information regarding the content corresponding to the characteristic of the content from the external server.

4. The controlling method as claimed in claim 1, wherein the generating the terminal-based content profile comprises generating the terminal-based content profile by mapping a viewing pattern of a user by time and by day.

5. The controlling method as claimed in claim 4, wherein the generating the terminal-based content profile comprises accumulating a viewing time by content genre, and updating a name of a content most recently viewed on the terminal-based content profile.

6. The controlling method as claimed in claim 1, further comprising determining, by the external server, a similarity between information included in a day and time of the terminal-based content profile and the context information corresponding thereto,
wherein the received advertisement content corresponds to a content and an external apparatus of which the similarity is greater than a preset value.

7. The controlling method as claimed in claim 1, wherein the displaying further comprises:
displaying additional information related to a content currently being played and the context information of the electronic apparatus.

8. The controlling method as claimed in claim 3, wherein the content recognition technology is at least one from among automatic content recognition and optical content recognition.

9. An electronic apparatus comprising:
a display;
a communicator configured to communicate with an external apparatus and an external server; and
a processor configured to:
generate a terminal-based content profile comprising viewing history information and external apparatus usage information by time,
transmit the terminal-based content profile to an external server through the communicator,
in response to an event to play an advertisement content occurring, acquire context information of the electronic apparatus and transmit the acquired information to the external server through the communicator,
receive an advertisement content determined based on the terminal-based content profile and the context information of the electronic apparatus from the external server through the communicator, and
control the display to display the received advertisement content on the display.

10. The electronic apparatus as claimed in claim 9, wherein the content viewing history information comprises information regarding a content that a user watches for each time period obtained by using a content recognition technology and metadata received from an external server through the communicator,
wherein the external apparatus usage information comprises characteristic information of the external apparatus acquired from the external apparatus, and
wherein the context information of the electronic apparatus comprises the external apparatus usage information currently recognized and information regarding a content currently being played received from the external server through the communicator.

11. The electronic apparatus as claimed in claim 10, wherein the processor is further configured to transmit a characteristic of a content that is being viewed by the electronic apparatus to the external server though the communicator, and receive information regarding a content corresponding to the characteristic of the content from the external server through the communicator.

12. The electronic apparatus as claimed in claim 9, wherein the processor is further configured to map a viewing pattern of a user by time and by day, and generate the terminal-based content profile.

13. The electronic apparatus as claimed in claim 12, wherein the processor is further configured to accumulate a viewing time by content genre and update a name of a content most recently viewed to the terminal-based content profile.

14. The electronic apparatus as claimed in claim 9, wherein the received advertisement content corresponds to a content and an external apparatus of which a similarity between information included in a day and time of the terminal-based content profile and the context information corresponding thereto, is greater than a preset value, the similarity being determined by the external server.

15. The electronic apparatus as claimed in claim 9, wherein the processor is further configured to control the display to display additional information related to a content currently being played and the context information of the electronic apparatus.

16. The electronic apparatus as claimed in claim 11, wherein the content recognition technology is at least one from among automatic content recognition (ACR) and optical content recognition (OCR).
